(19) United States
(12) Patent Application Publication
(10) Pub. No.: US 2021/0176402 A1
(43) Pub. Date: Jun. 10, 2021

(54) Image Capture Eyepiece

(71) Applicants: Robert James Beringer, Rosenberg, TX (US); David Allen Barbee, Harlingen, TX (US)

(72) Inventors: Robert James Beringer, Rosenberg, TX (US); David Allen Barbee, Harlingen, TX (US)

(21) Appl. No.: 17/094,508

(22) Filed: Nov. 10, 2020

Related U.S. Application Data
(60) Provisional application No. 62/937,463, filed on Nov. 19, 2019.

(51) Int. Cl. H04N 5/232; G03B 13/06

(52) U.S. Cl. CPC H04N 5/232061; G03B 13/06; H04N 5/23216

(57) ABSTRACT

An eyepiece has image capture, recording, processing and transmission capabilities, and is provided in several form factors, including binoculars in the shape of a pair of beverage bottles. Features include posting captured images to social media, image macro generation and posting to social media, and live broadcasting of video to social media.

### RELATED APPLICATION

This application claims priority to U.S. Provisional Application Ser. No. 62/937,463 for an “Image Capture Eyepiece,” filed Nov. 19, 2020, and currently co-pending, the entirety of which is incorporated herein by reference.

### FIELD OF THE INVENTION

The present invention pertains generally to image capture device for use in photography and video. More particularly, the present invention pertains to an image and video capture eyepiece with social media capabilities. The Present invention is particularly, but not exclusively, useful as a device for content creation and sharing.

### BACKGROUND OF THE INVENTION

Venues for sporting events, concerts, and other forms of entertainment often sell tickets at prices corresponding to proximity to the locus of the event (the field, stage, etc.), or corresponding to quality of the view of the event from the location corresponding to the ticket. Thus, the most inexpensive tickets generally correspond to the seats furthest from the action. In order to compensate for the distance, handheld magnifying aids such as binoculars are sometimes used. However, the magnification of such handheld apparatus is limited, since more than 3- to 5-fold magnification can also prevent a good view due to the apparatus shaking from small, involuntary hand movements. Moreover, handheld apparatus are often difficult to use with a separate camera, so even when a spectator in a distant seat is enabled to get a better view of the event, the spectator is often still unable to capture photographs of the event.

The combination of camera and ubiquitous Internet access in modern smartphones has, together with social media networks, created an increase in media creation and sharing among the public that would be hard to overstate. No longer is the widespread distribution of photographs or video limited to the work of a professional class. Anyone with a mobile phone can take a photograph or video and publish it to the world through popular social websites, and an extraordinary number of people do so.

As the smartphone has become universal, a need has arisen for new media creation devices for novelty, aesthetic appeal, and to overcome shortcomings of the smartphone, such as the difficulty of implementing optical zoom in the smartphone form factor, or for providing a simplified user interface or alternative convenient form factors.

In light of the above, it would be advantageous to provide an image capture device that provides the aforementioned benefits while allowing convenient sharing of content to social media. It would be further advantageous to provide an image capture device with image filtering, image effects, and meme generation capabilities to allow for the creation and upload of more varied content.

### SUMMARY OF THE INVENTION

Disclosed is an eyepiece with image capture, recording, processing and transmission capabilities. Various embodiments provide various form factors, including eyeglasses, sunglasses, snow and swim goggles, monocles, monoculars, and binoculars.

A set of preferred embodiments have a binocular form factor, which provides the benefit of providing extra room for more powerful electronics, greater battery capacity, and zoom capabilities than can be implemented in more restrained form factors such as eyeglasses and sunglasses. At the same time, binoculars are not uncommon at sporting events, certain tourist attractions such as national parks, and even some other forms of entertainment such as operas, which allows the binocular-type image capture eyepieces to be used in a variety of situations without seeming out of place. At least one preferred embodiment extends on the binocular form factor by providing the binoculars in a design of a pair of beverage bottles, resulting in a unique aesthetic appeal for situations such as sporting events.

The image capture eyepiece of the present invention provides a user interface that is engaged by the user to perform operations such as capturing an image, applying filters or effects to a captured image, uploading the captured image—with filters or effects if applied—to social media, capturing an image and immediately uploading it to social media, and capturing and streaming live video to social media. In some embodiments, the user engages the user interface to perform these and other operations through voice commands received through a microphone on the image capture eyepiece. In other embodiments, these operations are performed when the user engages the user interface by pressing a button located on the eyepiece and associated with the desired operation. The user interface in some embodiments is engaged with both voice commands and one or more buttons. In some embodiments, one or more buttons are programmable by the user to be associated with operations that the user desires to be performed when the button is pressed.

A communications feature, which includes a communications port such as a USB port, a Bluetooth radio, a Wi-Fi radio, or a combination thereof, allows the image capture eyepiece to connect to the Internet and to an external computing device such as a mobile phone or a personal computer. The external computing device is used to connect the image capture eyepiece to the user's social media accounts or other cloud services for the uploading of images and video, and also to configure other settings on the image capture eyepiece as desired by the user. As mentioned above, some embodiments of the image capture eyepiece have at least one button (preferred embodiments have anywhere from zero to ten buttons). The button or buttons can each be associated with an operation desired by the user through the configuration feature provided by the external computing device. Once configured, the user can perform that operation at any time by pressing the corresponding button on the eyepiece.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a conceptual diagram of image capture, storage, and sharing features of a preferred embodiment of an image capture eyepiece of the present invention;

FIG. 2 is a conceptual diagram of venue-related features of a preferred embodiment of an image capture eyepiece of the present invention;

FIG. 3 is a perspective view of a preferred embodiment of an image capture eyepiece of the present invention;

FIG. 4 is a perspective view of a preferred embodiment of an image capture eyepiece of the present invention showing a pop-up display;

FIG. 5 is a perspective view of an alternate preferred embodiment of an image capture eyepiece of the present invention;

FIG. 6 is an illustration of a computing device user interface for configuring social network and storage preferences for an image capture eyepiece; and

FIG. 7 is an illustration of a computing device user interface for configuring button press actions for an image capture eyepiece.

### DETAILED DESCRIPTION

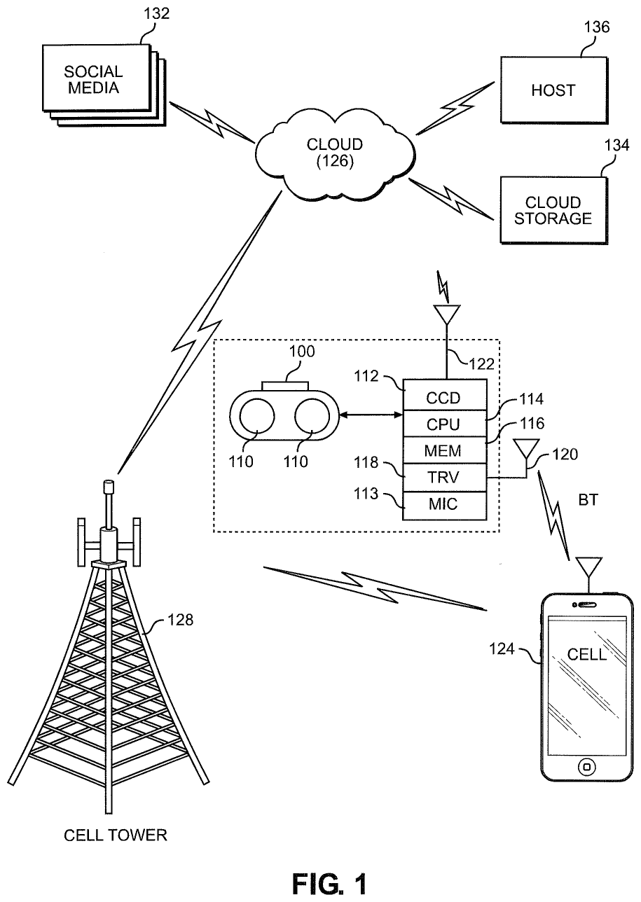

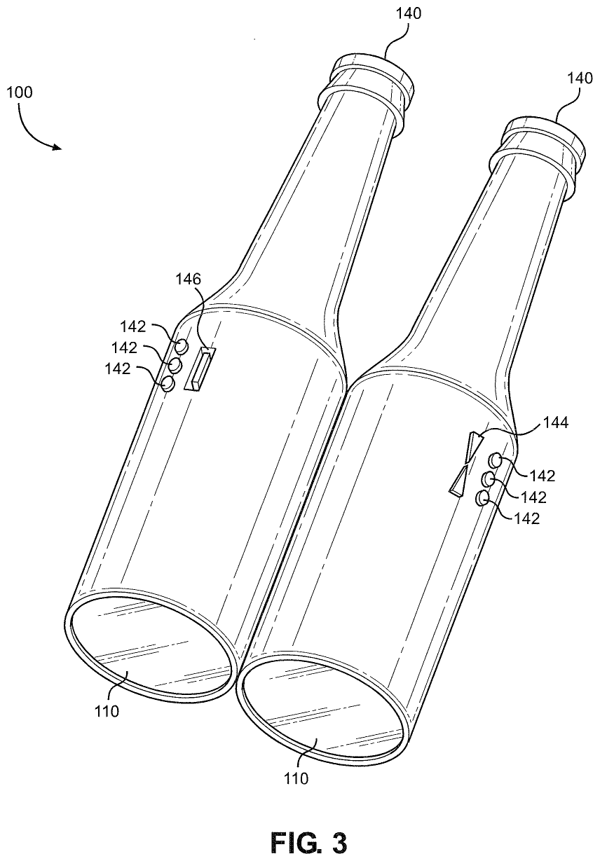

Referring initially to FIG. 1, an image capture eyepiece 100 has at least one camera that has a lens 110 and digital imaging circuitry 112 made with charge-coupled devices (CCD), active-pixel sensors (APS), or other digital image sensors. A microphone 113 is used for capturing audio, both during video and for processing voice commands. A CPU 114 and memory 116 allow for the storage and processing of captured images and video. An I/O component 118 includes a Bluetooth radio 120, a Wi-Fi radio 122, or, in preferred embodiments, both. Some preferred embodiments further include a wired I/O port 146 (shown in FIG. 3), such as a USB port, which is a standard, mini, micro, or type-C USB port, depending on the embodiment.

Bluetooth radio 120 provides a convenient form of I/O communication with mobile devices 124 such as smartphones, and provides image capture eyepiece 100 with an indirect connection to the Internet 126 when connected through

Bluetooth to an Internet-connected mobile device 124, which normally connects to the Internet 126 through a cell tower 128. Wi-Fi radio 122 allows image capture eyepiece 100 to connect to the Internet 126 through a wireless access point, allowing a user to upload images and video to social media 132, online storage 134, or some other Internet 126 host 136 without a Bluetooth connection to an Internet-connected mobile device 124. Host 136 may be a privately-owned or rented server running software such as MediaGoblin or other media hosting or streaming software, a news website, or other Internet 126 site. Some embodiments of image capture eyepiece 100 allow a user to save images and video to a local network, for example, to a shared drive on a local network device. In such embodiments, Wi-Fi radio 122 also provides access to the local network through the wireless access point.

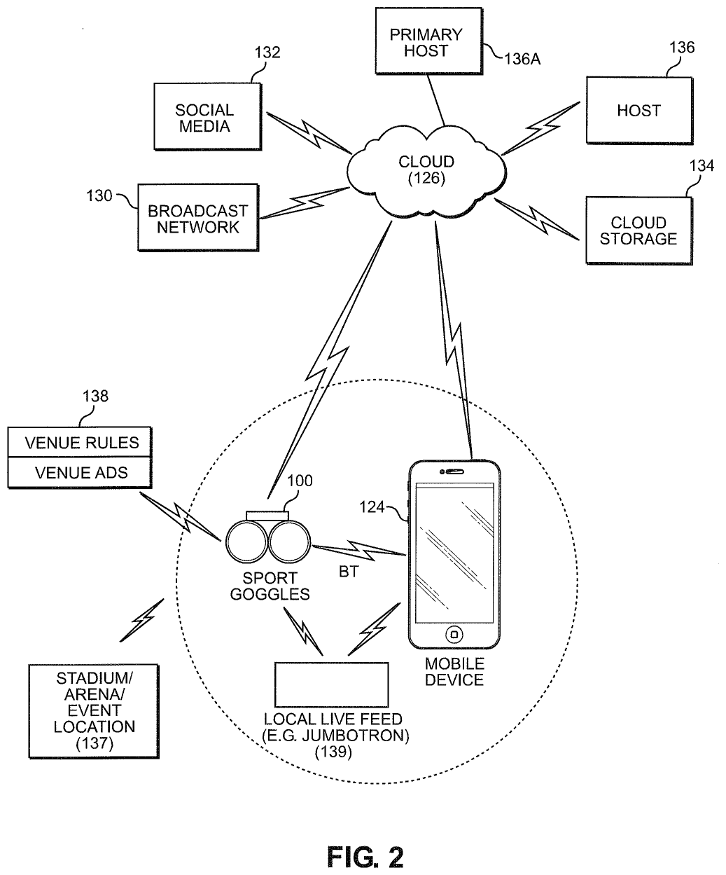

Referring now to FIG. 2, image capture eyepiece 100 is illustrated at a particular venue 137, representing a location in which a user might want to take photographs or video. Venue 137 could be a stadium or arena for a sporting event, a concert hall, a national park, or any other location in which a user of image capture eyepiece 100 might desire to use an image capture eyepiece 100.

Some preferred embodiments of image capture eyepiece 100 receive venue content 138. Venue content 138 may consist of policies or rules to be automatically implemented by image capture eyepiece 100, such as a prohibition on photography in certain places, or a prohibition on flash photography. For example, venue 137 might be a museum which includes a policy against flash photography among the venue content 138; upon entry into venue 137, image capture eyepiece 100 would receive the venue content 138, including the policy against flash photography, and would not use flash inside the venue 137. As another example, venue 137 might be a protected park area or natural preserve which requests visitors not to provide the location for photographs of certain sites on social media, or to provide only the park or preserve name rather than specific location data. Venue content 138 could provide a policy supporting that request by preventing image capture eyepiece 100 from including location information in image metadata. Venue content 138 may also include advertisements intended for visitors to venue 137.

In some embodiments, venue content 138 is provided to image capture eyepiece 100 over the Internet 126 from a predetermined server. In other embodiments, the venue 137 provides venue content 138 through its own equipment, such as an Internet server, or through a local wireless network, a local radio signal, or other predetermined form of transmission. Geofencing technology may also be used to identify when image capture eyepiece 100 is in venue 137 and affect the operation of image capture eyepiece 100. In order to prevent unauthorized manipulation or control of image capture eyepiece 100, or unwanted advertisements from third parties impersonating a venue 137, when venue content 138 is provided from a specific venue 137, SSL-based certificate technology or similar security measures are used to identify venue 137 before image capture eyepiece 100 accepts venue content 138. Some preferred embodiments of image capture eyepiece 100 have recognized certificates preinstalled, which are updated from a trusted source from time to time. Moreover, some embodiments of image capture eyepiece 100 use a database of known venues 137 in refusing all venue content 138 when not in a location corresponding to a known venue 137.

Venue 137 may have a local content display 139. For example, where venue 137 is a stadium, a jumbotron may be present and act as a local content display 139. Some venues 137 accept photographs and video from image capture eyepieces 100, or from mobile devices 124 connected to image capture eyepieces 100. The venue 137 selects from the received photographs and video for display on local content display 139. Likewise, some embodiments of image capture eyepiece 100 allow a user to share photographs and video with a broadcast network 130, such as a network with a license to broadcast sporting events from a particular league, from which the broadcast network 130 selects content to include in its programming. Where broadcast licensing is involved, venue content 138 may include rules limiting livestreaming during events to be performed through the appropriate licensed broadcast network 130 for the duration of the event. A particular venue 137 may also have a particular policy in venue content 138 limiting all livestreaming from image capture eyepieces 100 to one or more specific livestream hosts having an agreement with the venue 137.

In a preferred embodiment, image capture eyepiece 100 is configured to receive services from a particular predetermined primary host 136A that provides venue content 138 or security certificates for identifying trusted providers of venue content 138, firmware updates, and other features. In some embodiments, the primary host 136A also provides social networking and gamification features, such as image and video sharing, contests based on photo or video uploads, the ability to sell captured photographs and video as stock imagery and video, an application programming interface (API) for venues 137 to provide venue content 138 to image capture eyepiece 100 via the primary host 136A, APIs for additional features and services provided by third parties through the primary host 136A, or other features.

An API may also be provided by the image capture eyepiece 100 itself in order to allow third party applications to provide additional features to the image capture eyepiece 100. In some embodiments, such third party applications run on connected mobile device 124; in other embodiments, the applications run on the hardware of image capture eyepiece 100 itself. In some embodiments, separate APIs are provided, allowing third party developers to develop applications for the image capture eyepiece 100 that run on the mobile device 124 and applications that run on the hardware of the image capture eyepiece 100.

In some embodiments, a website associated with primary host 136A provides relevant, up-to-the-minute content related to ongoing events by aggregating photos, videos, memes, and comments from users of image capture eyepieces 100 for each venue 137. Where a rights-holding broadcast network 130 is involved, the website may direct users to a website associated with broadcast network 130 with similar features. This allows an event such as a sports competition to be covered by many cameras, potentially hundreds or thousands, in addition to the limited number of professionally operated cameras filming the event.

Referring now to FIG. 3, an exemplary preferred embodiment of an image capture eyepiece 100 is illustrated, in which the image capture eyepiece 100 has the form of binoculars designed to look like beverage bottles. Various embodiments have the appearance of different types of beverage bottles, standard binoculars, and other objects. A preferred embodiment has a single camera with a lens 110 and digital imaging circuitry 112; the lens 110 may be formed into an end of one of the beverage bottle designs as shown, or may be on a separate piece of hardware attached to the beverage bottle portion of the image capture eyepiece 100. Viewports 140 display the image being detected by the digital imaging circuitry 112, and, after an image capture or while using editing features (for example, applying filters or effects, or meme generation) the viewports 140 display the captured image, including any applicable alterations made during editing.

Some alternative preferred embodiments provide two lenses 110 with associated digital imaging circuitry 112, allowing for the creation of stereoscopic or 3D image and video creation. In capturing a stereoscopic image, a left frame image and a right frame image are taken. These may be processed to generate an anaglyph or other presentation format either through onboard software on the image capture eyepiece 100 for immediate upload to social media, or through an external computing device. 3D video is created in a similar manner, capturing a left frame image and a right frame image for each video frame, and processing it into an appropriate video format, such as a two channel video for viewing with a pair of polarized projectors and eyeglasses with polarization filters, anaglyph, alternating frames for use with active shutter glasses, or other 3D video formats known in the art.

Other preferred embodiments have two lenses 110 with one lens 110 being a wide-angle or ultra-wide-angle lens, and the other lens 110 providing standard and long-focus views.

Some preferred embodiments of image capture eyepiece 100 have buttons 142 for performing common operations such as taking a photograph. An embodiment has a single button 142, while some other embodiments have a greater number of buttons 142. In preferred embodiments, these buttons 142 are programmable by the user to be associated with desired operations.

A zoom capability is present in some preferred embodiments of image capture eyepiece 100. In preferred embodiments with zoom capability, at least a portion of the zoom capability is performed by altering the focal length of lens or lenses 110 (“optical zoom”) rather than through digital image processing in order to provide a better optical resolution of the captured image. The zoom feature is activated through zoom buttons 144. Image stabilization is used to avoid “camera shake,” allowing a user to clearly view and take clear photographs even when the zoom feature is activated.

Some preferred embodiments also provide ultra-wide-angle capabilities, allowing image capture eyepiece 100 to capture a wide field of view, generally one-hundred degrees or greater, and in some embodiments up to one-hundred-eighty degrees. Among the benefits of an ultra-wide-angle view is the ability for users in the closest seats to an athletic event to view and photograph the entire field.

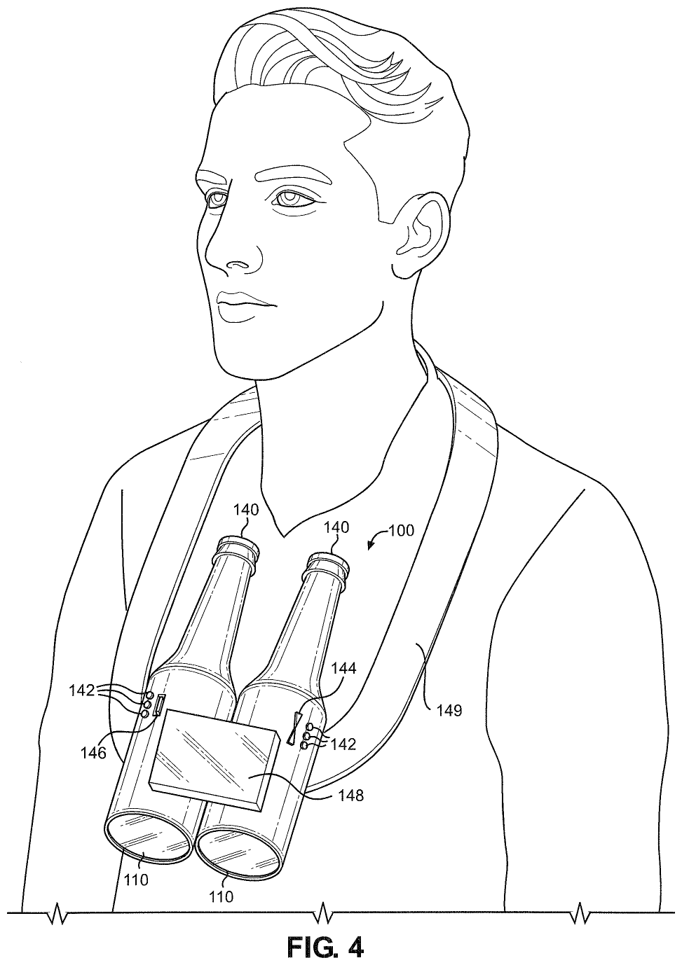

A physical I/O port 146 in some preferred embodiments allows the image capture eyepiece 100 to communicate with an external computing device when connected using a data cable. The physical I/O port is often used when connecting an image capture eyepiece 100 to a personal computer or laptop without Bluetooth capabilities, or in situations in which Bluetooth is unavailable or undesired for connecting to a mobile device. A wired connection, as with a Bluetooth or other wireless connection, allows for configuration of the image capture eyepiece 100 as discussed in conjunction with FIGS. 3 and 4 below, as well as transfer of images and video between the image capture eyepiece 100 and the connected device.

Referring now to FIG. 4, certain preferred embodiments of image capture eyepiece 100 also have a popup screen 148 that rests against the image capture eyepiece 100 in a closed configuration and opens outward to be viewable by a user in an open configuration. A preferred embodiment of screen 148 is a seven-inch screen. Screen 148 combined with zoom features of the image capture eyepiece 100 provide a user with a close-up view of the action in a venue 137, even when the user has a seat distant from the event itself. Unlike the display on a jumbotron, or viewing the event from a television at home or at a restaurant, popup screen 148 on image capture eyepiece 100 allows the user to zoom in and out at will, and focus on specific portions of the activity according to the user's own desires. Popup screen 148 combined with zoom and image stabilization features allows the user to get a clear, stable view of the action. In embodiments with ultra-wide-angle capabilities, a user in close-up seating at an event is enabled to see more of the action on popup screen 148, such as an entire football field, and, as desired, film or photograph the wider view.

Popup screen 148 also provides a medium for the display of local advertisements or other notifications from venue content 138. For example, venue 137 may provide an advertisement for a restaurant located inside or near venue 137, or safety information, or other content to be displayed on popup screen 148.

A harness 149 is present in some preferred embodiments and allows a user to wear the image capture eyepiece 100 while viewing the popup screen 148. In a preferred embodiment, harness 149 is designed to be worn around the chest, and holds the image capture eyepiece 100 at a position away from the user's chest comfortable for viewing popup screen 148. In an alternate preferred embodiment, harness 149 is designed to be worn on the head, and positions image capture eyepiece 100 upside-down so that popup screen 148 folds downward into a position visible to the user. The user can then move the user's head to view on the screen 148 a desired object at a desired level of magnification. As illustrated in FIG. 4, another preferred embodiment of harness 149 is designed to be worn around the neck, and allows the image capture eyepiece 100 to be angled as needed to record the desired activity.

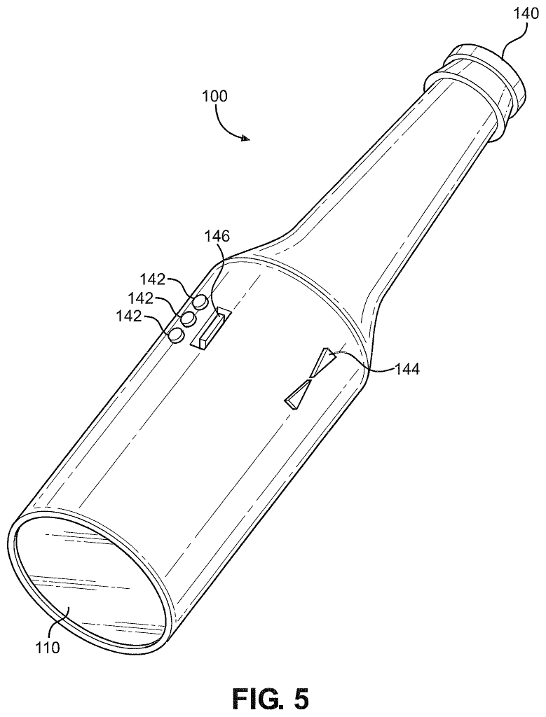

Referring now to FIG. 5, an alternate preferred embodiment of an image capture eyepiece 100 of the present invention is illustrated, wherein the eyepiece 100 is shaped like a single bottle. Alternate single-lens embodiments have other bottle shapes, telescope shapes, or are shaped like other objects. In the depicted embodiment and the aforementioned alternate single-lens embodiments, eyepiece 100 has a single lens 110. A harness 149 (not shown in FIG. 5) and a popup screen 148 (not shown in FIG. 5) adapted to the size of single-lens image capture eyepiece 100 are also present in some embodiments.

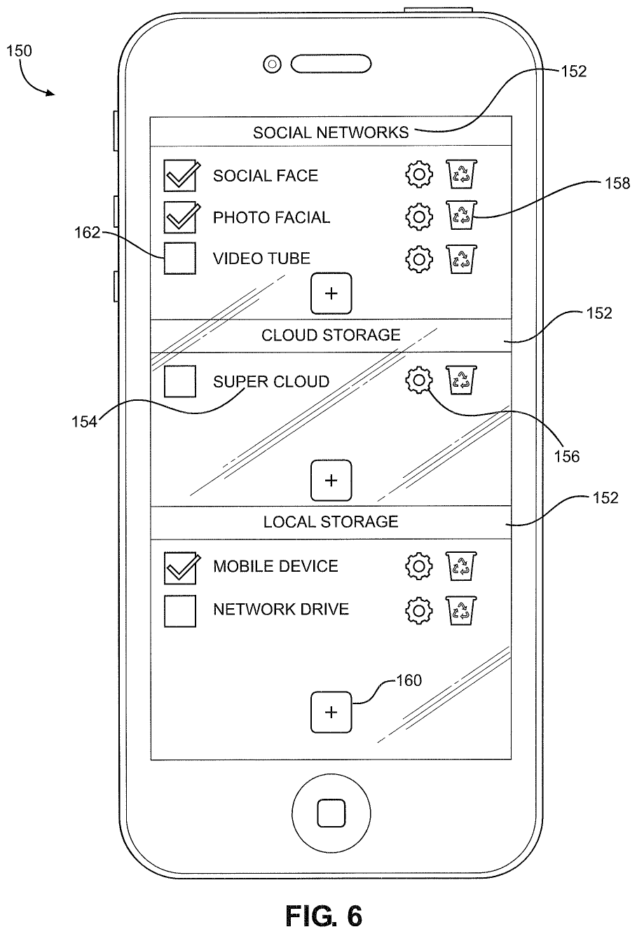

Referring now to FIG. 6, an exemplary user interface 150 is shown in order to illustrate the storage and sharing capabilities of an image capture eyepiece 100 and their configuration. Interface 150 displays categories 152 of destinations to which image capture eyepiece 100 can transfer media. In each category 152 is displayed individual destinations 154, such as a social media site, a cloud storage host, or other place to post, upload, or otherwise transfer media items such as images and video from the image capture eyepiece 100. A configuration element 156 is engageable by the user to enter or update settings for that destination 154, such as a username and password, and any other information that might be necessary to enable image capture eyepiece 100 to transfer media to the corresponding destination 154. A user may no longer wish to use a particular destination 154, and so may engage a removal element 158 corresponding to the destination 154 that is no longer desired. A new destination 154 may be added by engaging an add element 160. The particular details of the interface provided upon engaging an add element 160 depend on the category 152 to which the add element 160 pertains. Alternatively, there may be a single add element 160 for all categories, and the interface shown upon engagement of the add element 160 would adapt as the user selects a category 152 or a destination 154 corresponding to a particular category 152.

In a preferred embodiment, the add element 160 corresponding to the social network or social media category 152, when activated, presents a list of social networks from which the user selects the desired social network to be added, and then provides the user's login credentials. Likewise, the add element 160 corresponding to the cloud storage category 152, when activated, presents a list of cloud storage hosts from which the user selects a host and provides credentials. Other types of hosts for which a category 152 is provided in some embodiments have corresponding interfaces requesting the appropriate information. The add element 160 corresponding to the local network storage category 152 presents a slightly different interface when activated in preferred embodiments, since it must request information about the type of storage desired, for example, whether the user wishes to transfer the data to a mobile device (e.g. via Bluetooth), or to a shared drive or file server on the local network, or some other local network storage option. The user then must indicate the particular device desired to be added as a destination 154, which in some instances will be selectable from an automatically populated list, and in other cases must be entered by the user as a host name, IP address, or some other identifier. Whether a selection list can be automatically populated or whether the user has to enter a previously known identifier will depend on the protocol used, the local network settings, the type of host being selected as a destination 154, and other factors that vary between specific networks, protocols, and devices. Once a particular storage option is selected as a destination 154, credentials are entered, if needed, in order that the image capture eyepiece 100 will be able to transfer media to that destination 154.

In some preferred embodiments, the image capture eyepiece 100 will transfer media to all appropriate destinations 154 upon receipt of a user command that includes transferring media. That is, the media will transfer to all destinations 154 configured for receipt of the particular type of media being transferred. For example, in most cases video will be transferred to all destinations 154, while images will be transferred to all destinations 154 except for video hosting services that don't support still images. Some alternative preferred embodiments include a toggle element 162 for each destination 154, which allows a user to temporarily deactivate the corresponding destination 154 without entirely deleting it via the removal element 158. While a destination 154 is deactivated, media transfer commands will not transfer media to the deactivated destination 154.

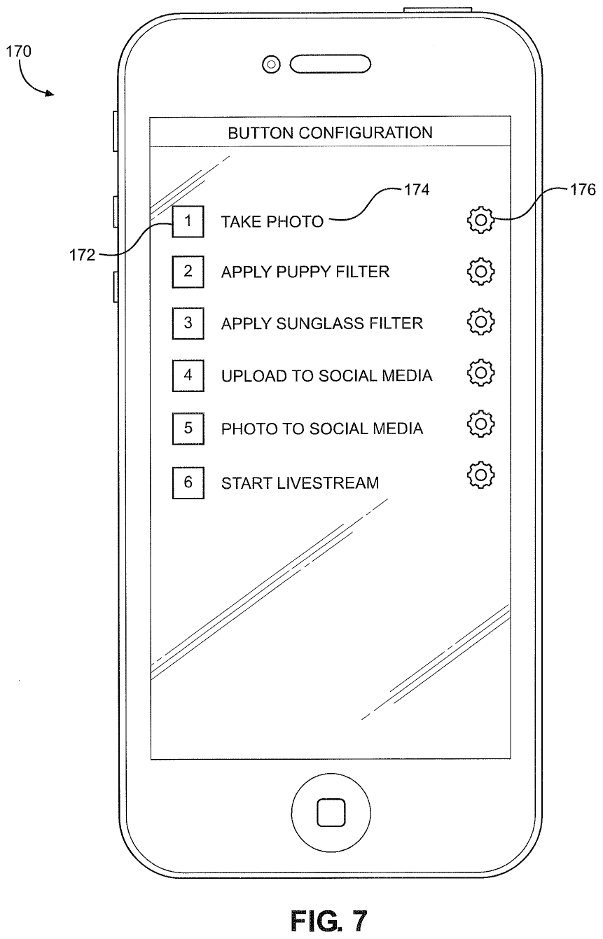

Referring now to FIG. 7, an exemplary user interface 170 is shown in order to illustrate the button 142 programming capabilities of some preferred embodiments of image capture eyepiece 100. Interface 170 includes an identifier 172 corresponding to each button 142 present on the image capture eyepiece 100, although identifier 172 may not be present in some embodiments in which image capture eyepiece 100 only has a single programmable button. Associated with each identifier 172 is a user command or action 174, if an action has been configured for the button 142 corresponding to the particular identifier 172. The action 174 is a user command that causes the image capture eyepiece 100 to perform an action, such as taking a photo, or a series of actions, such as taking a photo and uploading it to destinations 154 (shown in FIG. 6). An action 174 can be associated with an identifier 172 and its button 142, removed, or changed by engaging a configuration element 176. When engaged, configuration element 176 presents an interface allowing a user to add, change, or remove an action 174 with respect to a button 142 identified by the identifier 172 corresponding to the configuration element 176. In a preferred embodiment, the action 174 that the user desires to associate with the button 142 is selected from a list, which may include an option for no action if the user desires to remove the action 174 associated with that button 142.

While there have been shown what are presently considered to be preferred embodiments of the present invention, it will be apparent to those skilled in the art that various changes and modifications can be made herein without departing from the scope and spirit of the invention.

What is claimed is:

1. A media apparatus, comprising:
an image capture device comprising:
a body;
a camera having a lens and digital imaging circuitry;
a microphone;
a central processing unit (CPU);
a memory; and
an input-output (I/O) component,
wherein the image capture device is operable by a user to capture media and upload the captured media to one or more internet hosts, and
wherein the image capture device is configured to connect to a mobile device running an application operable by the user to select the one or more internet hosts to which to upload the captured media.

2. The media apparatus of claim 1, wherein the image capture device is configured to obtain venue content from a venue when the image capture apparatus is in the venue.

3. The media apparatus of claim 2, wherein the venue content comprises advertisements intended for visitors to the venue.

4. The media apparatus of claim 2, wherein the venue content comprises rules configured to limit the functionality of the image capture device while in the venue.

5. The media apparatus of claim 1, wherein the image capture device further comprises a popup screen.

6. The media apparatus of claim 5, further comprising a harness configured to allow the user to view the popup screen while wearing the image capture device.

7. The media apparatus of claim 1, wherein the body comprises a shape of two side-by-side beverage bottles.

8. A media apparatus, comprising:
an image capture device, comprising:
a body designed to simulate an appearance of beverage-bottle goggles;
viewports designed to simulate an appearance of beverage-bottle mouthpieces; and
one or more buttons,
wherein the viewports and the one or more buttons are located on the body, and
wherein a capture button of the one or more buttons is engageable by the user to capture media.

9. The media apparatus of claim 8, further comprising an application operable by the user to associate each button of the one or more buttons with a desired operation.

10. The media apparatus of claim 8, wherein an upload button of the one or more buttons is engageable by the user to send captured media to one or more internet hosts.

11. The media apparatus of claim 10, wherein the upload button and the capture button are the same button.

12. The media apparatus of claim 10, wherein the upload button and the capture button are distinct buttons.

13. The media apparatus of claim 8, wherein the image capture device is configured to obtain venue content from a venue when the image capture apparatus is in the venue.

14. The media apparatus of claim 13, wherein the venue content comprises advertisements intended for visitors to the venue.

15. The media apparatus of claim 13, wherein the venue content comprises rules configured to limit the functionality of the image capture device while in the venue.

16. The media apparatus of claim 13, wherein the image capture device is configured to allow the user to share captured media with the venue for display on a local content display.

17. The media apparatus of claim 8, wherein the image capture device further comprises two lenses and digital imaging circuitry configured for the creation of three-dimensional (3D) media.

18. The media apparatus of claim 8, wherein the image capture device further comprising a first lens and a second lens, wherein the second lens is a wide-angle or ultra-wide-angle lens.

19. The media apparatus of claim 8, wherein the image capture device further comprises zoom capability and zoom buttons operable by the user to engage the zoom capability.

20. The media apparatus of claim 8, wherein the image capture device provides an application programming interface (API) configured to allow third party applications to provide additional features to the image capture device.
